(19) United States
(12) Patent Application Publication
(10) Pub. No.: US 2008/0168123 A1
(43) Pub. Date: Jul. 10, 2008

(54) Web-based media file delivery to a media device

(75) Inventors: Jukka Ojanen, Vantaa (FI); Tero Salonen, Espoo (FI)

Correspondence Address: LADAS & PARRY LLP, 26 WEST 61ST STREET, NEW YORK, NY, 10023, US

(73) Assignee: LINKOTEC OY

(21) Appl. No.: 12/002,315

(22) Filed: Dec. 14, 2007

Related U.S. Application Data
(60) Provisional application No. 60/971,645, filed on Sep. 12, 2007.

(30) Foreign Application Priority Data
Dec. 18, 2006 (FI) 20065821

(51) Int. Cl. G06F 15/16

(52) U.S. Cl. 709/201

(57) ABSTRACT

Transferral of a media file to a media device comprises establishing a short-range connection (2-0) between the media device and a personal computer and an Internet connection (2-5) to the web server. The server transfers (2-10) a program module to the computer which determines (2-15) the media device's identity, eg IMEI. The program module joins (2-20) the short-range connection and the Internet connection to a combined connection between the media device and the web server. The computer sends (2-25) the buyer's detailed order and the media device's identity to the server, after which the server knows the buyer's detailed order and the media device's identity and it has available a combined connection to the media device. The server retrieves (2-30) from a database the ordered source files and uses (2-35) them and the media device's identity to prepare personalized media files for the buyer's media device.

### BACKGROUND OF THE INVENTION

The invention relates to methods, systems and computer program products for delivering one or more media files to a media device. In the present context, each media file is any mixture of image, audio, video, and/or program content. An illustrative but non-restricting commercial application of the present invention includes delivering media files from an Internet supply via a personal computer to a device which is capable of presenting the media files. Music or video players, game consoles and multimedia-capable telephones are representative examples of such media devices.

A traditional approach for buying media files via the Internet is to establish an Internet connection between the vendor's Internet server and the buyer's personal computer. As used herein, ‘personal computer’ is a general characterization of the type of computer being used; ownership of the computer is not essential, and the buyer may use any available computer, provided that the buyer can be identified. The identification may be based on a user name/password combination, for example. The media files being bought at a time are typically delivered as one single packed file, such as a zip file. Image, audio or video files are normally compressed optimally, and the additional packing to, say, a zip file is used for organisational purposes. It is simpler to deliver one zip file than a set of inter-related media files. It is normally the buyer's responsibility to unpack the zip file and transfer the unpacked media files to their correct destination in the media device.

The traditional media file delivery process is prone to certain errors. For instance, different media devices may use different names for the location of different media files, and the buyer may not be aware of such naming conventions. Also, the intermediate storage of the packed file in the personal computer is a risk as far as DRM (digital right management) is concerned.

### BRIEF DESCRIPTION OF THE INVENTION

An object of the invention is to develop a method, system and computer program product so as to alleviate one or more of the problems identified above.

### BRIEF DESCRIPTION OF THE DRAWINGS

In the following the invention will be described in greater detail by means of specific embodiments with reference to the attached drawings, in which:

FIG. 1 shows an illustrative environment in which the invention can be used; and

FIG. 2 is a signalling diagram illustrating a typical set of events in the environment shown in FIG. 1.

### DETAILED DESCRIPTION OF SPECIFIC EMBODIMENTS

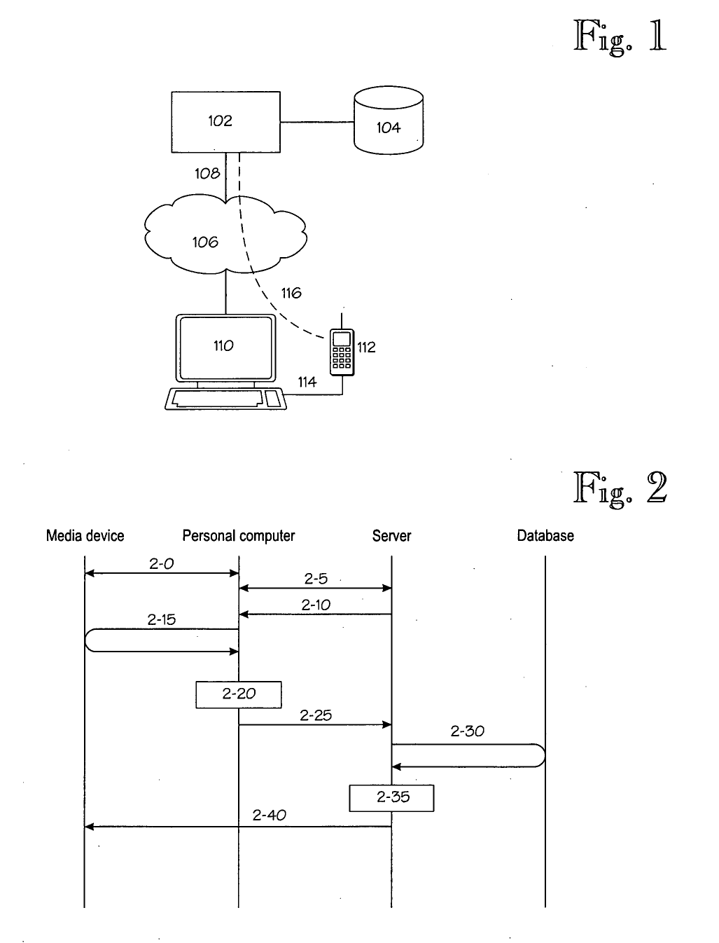

FIG. 1 shows an illustrative but non-restricting environment in which the invention can be used. A media file vendor maintains a web server 102 for delivering media files and an associated database 104 for storing source files from which a personalized media file will be created for each individual media device, as will be described later. The term “database” does not require or imply any particular organization, so long as it has sufficient capacity to store any required media files. The database may be the server's local database or a remote database.

The end-user (buyer) intends to play the media files in a media device 112, which may be a multimedia-enabled telephone, for example. The exemplary media device 112 is operatively coupled to a broadband mobile network, but even broadband mobile networks acts as bottlenecks for transferring very large files, such as video files. This is why the media device 112 is coupled to a personal computer 110, which is capable of establishing a connection 108 to the vendor's web server 102 via the Internet 106. The media device 112 is coupled to a personal computer 110 via a short-range connection 114, which may be a wired connection, such as a Local Area Network (LAN), IEEE1394 (FireWire) or Universal Serial Bus (USB) connection, or a wireless connection, such as a Bluetooth, Wireless Local-Area Network (WLAN) or an infrared connection. For the purposes of the present invention, it suffices that the short-range connection 114 has a reasonable bandwidth and that the media device can be identified via the short-range connection 114.

According to the invention, the web server 102 is operable to transfer a program module to the personal computer 110. For instance, the program module can be a stand-alone program or an extension (a plug-in) to a conventional web browser.

A residual problem is that many personal computers are provided with malware protection software, such as virus checkers and/or firewalls, which may restrict or prevent the transferral of the program module to the personal computer. Therefore, according to a preferred embodiment of the invention, the inventive program module is arranged to be activated via a dedicated protocol, the activation of which may be initiated by a clicking a link in a user interface screen provided by the web server. For instance, instead of a conventional link specifying http protocol (“http://www.mediaserver.com/ . . . ”), the link may be of the form “xyz://www.mediaserver.com/ . . . ” wherein the letters “xyz” signify the inventive protocol. By initiating the media file delivery via a link to a protocol, the personal computer's malware protection software is effectively bypassed.

The program module joins the short-range connection 114 and the Internet connection 108 to what is effectively a combined connection between the media device and the web server.

FIG. 2 is a signalling diagram illustrating a typical set of events in the environment shown in FIG. 1.

In step 2-0, a short-range connection, such as a LAN, USB, FireWire, Bluetooth or WLAN connection is established between the media device and the personal computer. In step 2-5 the personal computer establishes an Internet connection to the web server. In step 2-10 the server transfers the inventive program module to the personal computer. In step 2-15, the personal computer determines the media device's associated identity. Within the context of the present invention, the term “media device's associated identity” means an identity which with a reasonable certainty and uniqueness identifies either the media device itself, its owner or user, or a telecommunications subscription of the owner or user. Reasonable certainty means that it is not fatal if a small number of the world's media devices happen to use identical associated identities because this would only mean that a media file personalized for one of these media devices could be used in a few other media devices sharing the same associated identity. For instance, if the media device is a mobile telephone, it has an International Mobile Equipment Identity (IMEI), or its Sub-scriber Identity Module (SIM) has an International Mobile Subscriber Identity (IMSI). Such identities are globally unique. LAN and WLAN devices have a 48-bit long quasi-unique Media Access Control (MAC) address. This identifier alone does not identify the device but by combining the MAC address with additional information provided by for example Universal Plug and Play (UPnP), the media device can be uniquely identified. In other cases, the media device may have a unique serial number or the like. This is the case with all Media Transfer Protocol (MTP) devices. The Media Transfer Protocol is a protocol developed by Microsoft to transfer media files and associated metadata to/from media devices, for example digital audio players such as MP3 players, and other portable media devices, for example portable video players. Each device has a unique serial number and additionally devices certified for Microsoft® PlaysForSure have a unique device certificate.

In step 2-20 the inventive program module joins the short-range connection 114 and the Internet connection 108 to a combined connection between the media device and the web server. This combined connection is denoted by a dashed line 116 in FIG. 1. In step 2-25, the personal computer sends the buyer's detailed order and the media device's identity to the server. The detailed order specifies the media files which the user intends to buy. Creation of the detailed order may involve several messages between the personal computer and the server, but such order-creation steps are routine for persons skilled in the art of network shopping. What matters is the fact that after step 2-25, the server knows the buyer's detailed order and the media device's identity and it has available a combined connection to the media device. What is irrelevant is the mutual order and number of detailed sub-steps or messages needed to provide the server with such information.

In step 2-30 the server retrieves from a database the source files needed to fulfil the buyer's detailed order. In step 2-35 the server uses the source files and the media device's identity which was determined in step 2-15, such as its IMEI, IMSI, MAC/UPnP combination, serial number or the like, to prepare media files which are personalized for the buyer's media device. The purpose of this step is to enforce copyright by coupling the media files to a particular media device. Other than that, the personalization is not strictly necessary to overcome the problems listed in the background section of the invention. It is beneficial if the server also packs the personalized (if so desired) source files into a single delivery file. The purpose of this step is to facilitate the transferral of the media files to the media device. By packing all of the ordered media files to a single delivery file, it is easier to monitor the success or failure of the transmission. In case of transmission failure, error-tolerant file transfer protocols may be used to begin re-transmission from the first packet whose transmission failed.

In step 2-40 the server transfers the media files, which preferably are in the form of a single delivery file, to the their intended destination in the media device. The server may deduct the intended destination, such as a folder name, from the nature of the media files and the type of the media device (or its software platform).

The invention and its embodiments can be used for seamless end-to-end content delivery which requires little or no attention from the buyer. The invention can be adapted for parallel loading of media file(s) to the buyer's personal computer and media device. Instead of media file downloading, or in addition to it, the invention is applicable to uploading media files from a media device to a web server.

The invention does not necessitate any hardware modifications, and in the apparatus aspects of the invention, the various means for performing steps of the inventive method may be embodied as data processing devices under control of processing routines which direct the data processing devices to carry out the steps of the inventive method.

It is readily apparent to a person skilled in the art that, as the technology advances, the inventive concept can be implemented in various ways. The invention and its embodiments are not limited to the examples described above but may vary within the scope of the claims.

1. A method for transferring a media file from a database coupled to a web server to a media device via a personal computer, wherein the media device has an associated identity; the method comprising:
coupling the media device to the personal computer via a short-range connection;
establishing an Internet connection between the personal computer and the web server;
in response to detecting the Internet connection between the personal computer and the web server, transferring a program module from the web server to the personal computer;
starting the program module in the personal computer;
the program module determining the identity of the media device;
the program module joining the Internet connection and the short-range connection to a combined connection between the media device and the web server;
the program module delivering the identity of the media device to the web server;
the web server using the associated identity of the media device to personalize the media file; and
the web server delivering the personalized media file via the personal computer to the media device.

2. A method according to claim 1, wherein the program module is a component operable to enhance the functionality of a web browser.

3. A method according to claim 1, wherein the program module is a stand-alone program.

4. A method according to claim 1, wherein the program module is operable to ensure integrity of the combined connection between the media device and the web server.

5. A method according to claim 1, wherein the short-range connection is a Universal Serial Bus connection or a Bluetooth connection.

6. A method according to claim 1, further comprising determining a destination location for the media file based on the nature of the media file and/or the type of the media device.

7. A method according to claim 1, further comprising determining the media device's associated identity based on one or more of the following identifying information:
the media device's International Mobile Equipment Identity;
the media device's International Mobile Subscriber Identity;
the media device's Media Access Control address with Universal Plug and Play information;
the media device's serial number;
the media device's unique device certificate.

8. A web server for transferring a media file from a database to a media device via a personal computer, wherein the media device has an associated identity; the web server comprising:
means for maintaining an Internet connection between the personal computer and the web server;
means, responsive to detecting the Internet connection between the personal computer and the web server, for transferring a program module from the web server to the personal computer, wherein the program module comprises program code portions for:
recognizing a short-range connection between the media device to the personal computer;
determining the identity of the media device;
joining the Internet connection and a short-range connection to a combined connection between the media device and the web server; and
delivering the identity of the media device to the web server;
means for using the identity of the media device to personalize the media file; and
means for delivering the personalized media file via the personal computer to the media device.

9. A program module configured to be transferable from a web server to a personal computer, for supporting transferral of a media file from a database coupled to the web server to a media device coupled to the personal computer;
wherein the program module in embodied in a tangible carrier and comprises program code portions for:
recognizing a short-range connection between the media device to the personal computer;
determining the identity of the media device;
joining the Internet connection and a short-range connection to a combined connection between the media device and the web server; and
delivering the identity of the media device to the web server.
